(19) United States
(12) Patent Application Publication
(10) Pub. No.: US 2026/0289350 A1
(43) Pub. Date: Sep. 24, 2026

(54) SELF-ADAPTIVE CONVERSATIONAL ROBOT SYSTEM

(71) Applicant: ILIAD, Paris (FR)

(72) Inventors: Patrick Escande, Paris (FR); Lucas d'Urso, Paris (FR); Jerome Rastit, Paris (FR)

(21) Appl. No.: 19/569,650

(22) Filed: Mar. 17, 2026

(30) Foreign Application Priority Data
Mar. 18, 2025 (EP) 25315084.1

(51) Int. Cl. G06N 5/04

(52) U.S. Cl. CPC G06N 5/04

(57) ABSTRACT

A conversational robot system comprising a modular workflow (100) segmented into a plurality of interconnected sub-modules (q0, q1, q2, . . . ) defining a progression of the workflow along a plurality of possible paths (a, b, . . . ), an inference service (300) based on large language models, LLMs, and an orchestrator module (200) coupled to the workflow and to the LLM inference service, and able to control transitions between the sub-modules of the workflow. The sub-modules comprise at least one sub-module including a deterministic state machine, at least one sub-module including a non-deterministic state machine, and at lease one sub-module including a fuzzy logic state machine. The LLM inference service is able to receive from the workflow requests emitted by at least one of the sub-modules, comprising: requests formulated by a user of the conversational robot; conversational context data; user context data; and/or historical data. It produces an LLM inference result from the received requests, selects in real time, as a function the LLM inference result, a current sub-module having emitted a respective request, and issues to the orchestrator module an order for executing the transitions selected by the LLM inference result for the selected current sub-module.

### TECHNICAL FIELD OF THE INVENTION

The invention relates to a conversational robot system.

Conversational robots, or conversational agents, usually called “chatbots” (usual word that will be used in the present disclosure) are automated software interfaces designed to establish a dialogue, in text or voice form, with users in order to guide them, step by step, towards answers to questions or requests for information formulated in more or less natural language.

Exchanges between the chatbot and the user progress in the form of a series of questions/answers controlled and guided by the chatbot, and which can be described by a path within a modular workflow.

### STATE OF THE ART

First chatbots were of the “rule-based” type, i.e. the workflow used predefined rules and decisional trees to answer to specific questions. However, this type of chatbot was limited to what had been programmed, with impossibility to handle complex or unexpected requests.

Chatbot performance and efficiency have been greatly improved by combining them with large language models (LLMs), implementing inference processes executing a pre-trained model to process requests from the workflow and generate corresponding actions in response, all using natural language processing (NLP).

However, such “AI-powered” chatbots are not without drawbacks and limitations.

Among the risks that may be encountered, the following can be mentioned:
lack of robustness in complex scenarios, with a risk of conversational drift (in multi-step conversations or in technical conversations, the chatbot may contradict itself or generate inconsistent responses), and/or production of redundant or useless answers (when a user repeats a request or asks a difficult question, the chatbot may give a generic answer or ignore the main point);
over-adaptation to the user's style by the chatbot, that tries to be too “pleasant” or “close” to the user, at the expense of accuracy (e.g. by accepting an erroneous assumption, to avoid contradicting the user); and
hallucinations, when the chatbot generates incorrect or fabricated information while appearing convinced of its validity.

These effects are mainly due to the fact that the LLM are probabilistic models based on statistical predictions, which can lead to credible but false answers, and that, on the other hand, the model does not intrinsically distinguish between “true” and “false” and may confuse similar or non-existent information, the model being unable to verify the facts that are presented to it or that are generated.

It is also observed that the chatbot may lose sight of the user's original objective during the conversation by becoming too general, ambiguous or even irrelevant.

Indeed, the LLM may lack contextual focus, with difficulty staying focused on a specific task, in particular in long conversations. And in open conversations, the broader the context, the greater the risk of deviation.

Finally, the present chatbots have a number of limitations such that:
contextual confusion: when the context becomes complex or if several topics are discussed simultaneously, the chatbot may lose track;
limited depth: although some chatbots are specialized in a particular field, they may lack precision when dealing with complex or technical subjects;
difficulty with specific tasks: generalist chatbots are not always effective at performing specific tasks that require specific business processes or knowledge;
limited logic: chatbots have difficulty with complex reasoning or problems requiring several steps; and/or
contradiction management: chatbots can generate contradictory or illogical responses within a same conversation, which may be obvious to the user but are not detected by the chatbot.

### DISCLOSURE OF THE INVENTION

The invention aims to propose a new chatbot structure that overcomes these drawbacks and limitations of current “AI-powered” chatbot solutions.

The invention relates to such chatbots based on LLM, and more specifically chatbots whose modular workflow integrates sub-modules with state machines.

The invention proposes in particular to realize a multi-modality hybrid chatbot, the workflow of which associates three different types of state machines, i.e.: at least one deterministic state machine, at least one non-deterministic state machine and at least one fuzzy logic state machine.

By “deterministic state machine”, it is understood a state machine that always follows a unique and predictable path for each given input, thus guaranteeing a perfectly controlled and reproducible behaviour.

By “non-deterministic state machine”, it is understood a state machine that can propose, for a same state and a same input, several possible parallel paths with a certain degree of unpredictability, thus allowing for greater flexibility and the possibility of exploring multiple scenarios concurrently (but with the downside of inability to determine with rigour and reliability the next step or the next task to be performed).

By “fuzzy logic state machine”, it is understood a state machine that manages degrees of uncertainty or probability for each transition from one state to the other, thus making it possible to incorporate nuances and behaviours that are closer to the way a human evaluates an ambiguous situation.

The base idea of the invention consists in combining and making interact:
the deterministic state machines, on the one hand for the general framework of the workflow and, on the other hand, inside mandatory or critical modules of the workflow;
the non-deterministic state machines, inside modules able to take into account the system context and the user context; and
the fuzzy logic state machines, inside modules capable of handling ambiguity or simultaneity of certain conditions prior to a change of state; and finally:
an LLM acting as a textual and decision-making engine, capable of understanding the requests in natural language, detecting the user's intention, retrieving relevant data, generating the interactions with the users, and triggering actions or state transitions based on probabilities and conversational context. It is also possible, and advantageous, to combine the LLM to known processes as such, such as “Function Calling” and RAG.

This unique combination of three state machines of different nature with an LLM allows the chatbot to navigate between multiple scenarios, and to dynamically chose the best transition as a function of the context, while integrating the power of text generation by the LLM and the ability to call external APIs.

More precisely, the invention proposes a conversational robot system comprising a modular workflow segmented into a plurality of interconnected sub-modules, wherein interconnection of the sub-modules defines a progression of the workflow along a plurality of possible paths from a current sub-module to a subsequent sub-module. The plurality of sub-modules comprises at least one sub-module including a deterministic state machine, at least one sub-module including a non-deterministic state machine, and at lease one sub-module including a fuzzy logic state machine.

The system also comprises an inference service based on Large Language Models, LLMs, and an orchestrator module coupled, on the one hand, to the workflow and, on the other hand, to the LLM inference service, and able to issue transition orders from a current sub-module to a subsequent sub-module of the workflow in accordance with a deterministic state machine logic.

The LLM inference service is able to: receive from the workflow requests emitted by at least one of the sub-modules and comprising a content of the group consisted of: requests formulated by a user of the conversational robot; conversational context data; user context data; historical data; and any combination of the above; produce an LLM inference result from the received requests; depending on the LLM inference result, select in real time a current sub-module, from said at least one of the sub-modules, having emitted a respective request; and issue to the orchestrator module an order for executing transitions selected by the LLM inference result for the selected current sub-module,

The LLM inference service is also able, depending on the LLM inference result, to produce a command of the group consisted of: a “Function Calling” order for the current sub-module to call a function; an order for activating or deactivating one or several states of the state machine of the current sub-module; a triggering of an optimization task of the retrieval-augmented generation, RAG, type; and any combination of the above.

Advantageously, each sub-module of the workflow is associated with its own repository comprising a content of the group consisted of: sub-module context data; a set of states of a state machine each defining a respective unitary action; a transition or a plurality of possible transitions between states of a state machine; a set of external functions liable to be called by the sub-module; and any combination of the above.

At least some sub-modules of the workflow can also be associated with their own repository comprising a history of the transitions between sub-modules;

The function called “Function Calling” can in particular be a task capable of triggering a command of the group consisted of: transitions between states of the state machine of the current sub-module; an interaction of the current sub-module with micro-services external to the workflow, independently of an LLM inference; an interaction of the current sub-module with micro-services internal to workflow, independently of an LLM inference; and any combination of the above. The RAG task can in particular be a task capable of interacting with the user of the conversational robot.

### BRIEF DESCRIPTION OF THE DRAWINGS

Exemplary embodiments of the invention will now be described, with reference to the appended drawing.

FIG. 1 is a synoptic diagram showing the general structure of the chatbot according to the invention.

FIG. 2 illustrates an example of a sub-module with a deterministic state machine integrated to the workflow of the chatbot of FIG. 1.

FIG. 3 illustrates an example of a sub-module with a non-deterministic state machine integrated to the workflow of the chatbot of FIG. 1.

FIG. 4 illustrates an example of a sub-module with a fuzzy logic state machine integrated to the workflow of the chatbot of FIG. 1.

### DETAILED DESCRIPTION OF EMBODIMENTS OF THE INVENTION

An example of implementation of the invention will now be described, with reference to the attached drawings in which the same references designate identical or functionally similar elements throughout the figures.

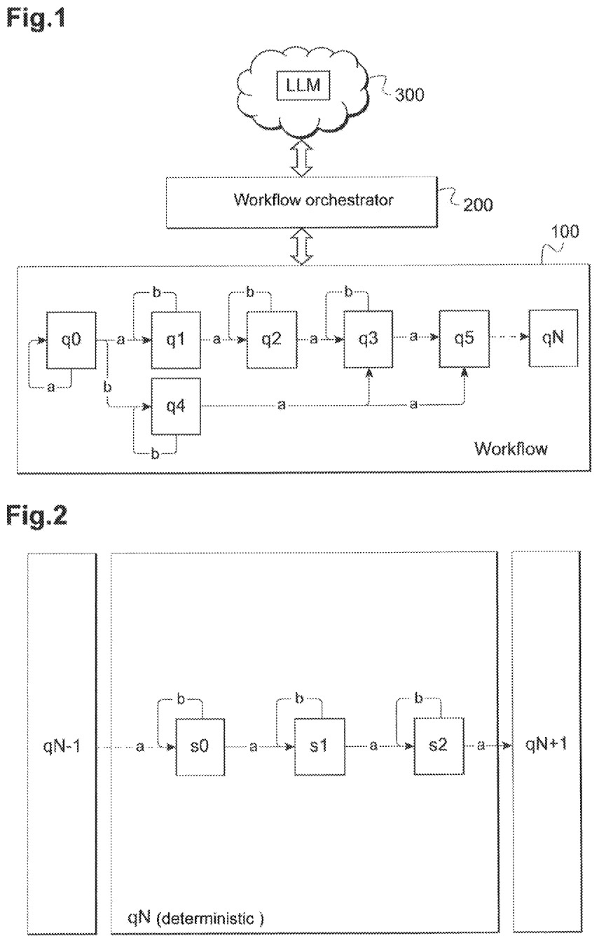

FIG. 1 illustrates the general architecture of the chatbot according to the invention, which includes a modular workflow 11, segmented into a plurality of sub-modules q0, q1, q2, . . . defining a progression of the workflow 100 along a plurality of possible paths a, b, . . . of a current sub-module qi+1, from an initial sub-module to a final sub-module.

The progression of the workflow 100 is controlled by a workflow orchestrator 200, which is also interfaced with an LLM inference service 300.

The LLM inference service 300 is external to the chatbot, it operates according to a mechanism that is known per se, and its operating mode does not need to be modified or adapted in order to implement the invention. With regard to the specific data on which the LLM is trained to produce the inference result, this data relates to the cognitive content of the workflow and is not part of the present invention.

The progression from a sub-module qi to the next sub-module qi+1 (e.g. a controlled progression along a path a or a path b, in the example of FIG. 1) is defined by a deterministic finite-state machine operated by the workflow orchestrator 200, so as to guarantee the robustness and reliability of the overall workflow path between the various sub-modules.

Each sub-module q0, q1, q2, . . . of the workflow 100 is associated with its own repository comprising: sub-module context data; a set of states of a state machine each defining a respective unitary action; a possible transition or plurality of transitions between states of a state machine; and/or, possibly, a set of external functions liable to be called by the sub-module.

Some sub-modules of the workflow can also be associated with their own repository comprising a history of the transitions between states and/or between sub-modules.

FIGS. 2 to 4 illustrate three possible types of sub-modules of the workflow 100.

Each of these sub-modules is defined by a context and predefined specific instructions or steps (s0, s1, s2, . . . in FIGS. 2 to 4) with transitions a, b, c, . . ., also specific, internal to the sub-module. These predefined steps or instructions correspond to the different possible states of the state machine, and will be simply referred to hereinafter by “states”.

The relations between the different states define a plurality of possible paths within the sub-module qN, from an input point interfaced upstream to the preceding sub-module qN−1, to an output point interfaced downstream to the next sub-module qN+1.

Within a same sub-module qN, the transitions between states are defined by a process of the state machine type.

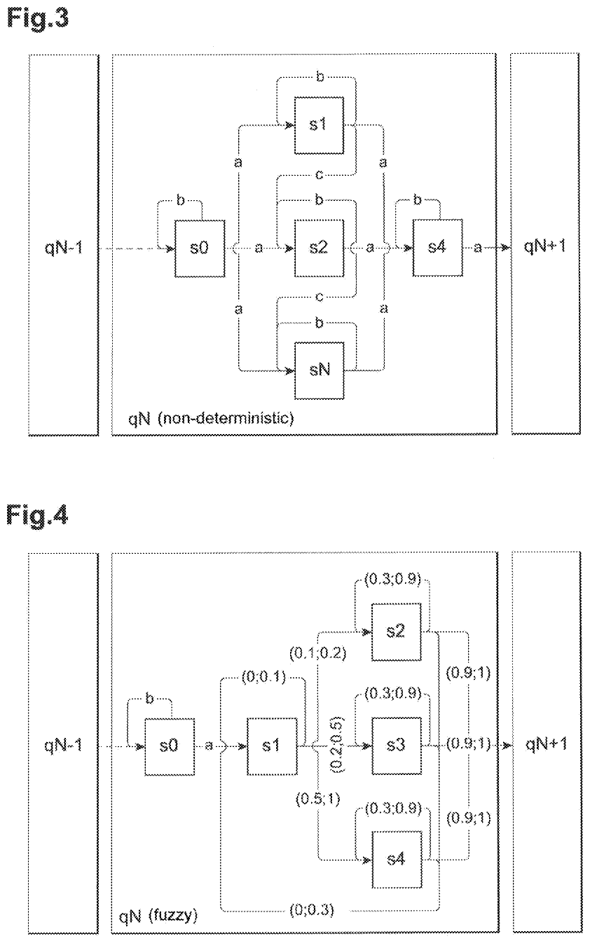

Characteristically of the invention, the various sub-modules of the workflow 100 combine, within the whole deterministic framework of the workflow 100 (according to the architecture illustrated in FIG. 1):
at least one sub-module controlled internally by a deterministic state machine (such as the sub-module illustrated in FIG. 2);
at least one sub-module controlled internally by a non-deterministic state machine (such as the sub-module illustrated in FIG. 3); and
at least one sub-module controlled internally by a fuzzy logic state machine (such as the sub-module illustrated in FIG. 4).

FIG. 2 illustrates an example of a sub-module with a deterministic state machine comprising three states s0, s1 and s2. A deterministic state machine sub-module is chosen for states of the chatbot that impose strict, highly restrictive conditions in order to guarantee the security of the overall system.

It may be, for example, a sub-module whose function in the chatbot is to accept the general terms and conditions of use (TCU) of a website with which a user wishes to converse and possibly place an order and make a payment. In such a use case, the function comprises a first state s0 of welcoming the user and informing them that they will need to accept the TCU, a second state s1 of presenting the TCU for the user to read, and a third state s2 of acceptance of the TCU by the user after reading them.

The transition from submodule qN to the next submodule qN+1, and therefore the continuation of the conversation between the chatbot and the user, will be conditional upon the user's confirmation of these three steps, with therefore “aaa” as the only acceptable path (and, if not, loop “b” on the unaccepted stage).

In another use case, the same type of sub-module controlled by a deterministic state machine can be used for a payment sub-module, with possibly several options available to the user within the sub-module (payment method, delivery type, . . .), but in all cases in a completely secure and risk-free manner.

Such deterministic state machine logic does not require LLM inference for transitioning from one state to another, as all transitions can be controlled by the state machine purely internally within the sub-module.

FIG. 3 illustrates an example of a sub-module with a non-deterministic state machine comprising five states s0, s1, s2, s4 and sN. Transitions a, b, c between the different states are controlled by a non-deterministic process, so as so provide a high degree of flexibility in implementing the sub-module: question management, user requests, open conversation, etc.

It may be for example a sub-module whose function is to present a product or service before purchase, with the option to browse multiple options.

In this example, the states of the state machine are for example:
s0: general presentation of the product or service, which may lead to
s1, s2 or sN,
s1: presentation of the product or service technical details,
s2: presentation of the user feedbacks,
sN: other subject or conversation, which will be managed by an LLM inference based on the current context, and
s4: confirmation sent to the user after they have made their choice, before moving on to the next sub-module qN+1 of the workflow, such as a purchase sub-module.

FIG. 4 illustrates an example of a sub-module with a fuzzy logic state machine comprising five states s0, s1, s2, s3, s4.

In such a fuzzy logic, instead of binary criteria (yes/no, condition met/not met, etc.), the logic assigns weights p (0≤p≤1) to the various possible transitions between states.

The aim is to replicate human behaviour in this way and to address questions that are formulated in free language in a non-quantified manner.

For example, when choosing a camera: “good image quality”, “easy to use”, “reasonable price”, etc.

The weighting applied will correspond to satisfaction levels assigned to each criterion, e.g. 0.6 for simplicity, 0.8 for image quality, etc.

The process implemented by the sub-module comprises the following successive steps, assisted by the LLM:
1) identification of the criteria: “image quality”, “simplicity of use”, “price”, etc. ;
2) assignment of partial scores and weighting: each criterion receives a fuzzy score, which is then multiplied by a weight;
3) fuzzy transitions: the transition from one state to the next one is operated based on combinations of scores; and
4) final aggregation to obtain the recommendation for a device.

As these steps involve LLM inferences, the workflow sends to the LLM service 300 non-quantified requests formulated by the user in natural language, and receives in return inference results allowing to rationally define the transitions between the states of the sub-module based on these requests.

Advantageously, and generally, all the interactions of the workflow 100 with the LLM inference service 300 can trigger “Function Calling” orders to perform subsidiary actions such as:
controlling the transitions between the states of the state machine of the current sub-module,
interaction of the current sub-module with a micro-service external to the workflow, here used independently of the LLM inference that has triggered the call of this service, and/or
interaction of the current sub-module with an internal micro-service, integrated to the workflow.

The called function, automatically triggered as a function of the context, enables for example to interact with services such as payment, CRM, database, etc.

The implementation of such a “Function calling” mechanism controlled by the LLM (but “agnostic” to the LLM model, i.e. independent of it), controlled by the LLM conjugated with the architecture associating three different types of sub-modules, provides higher conversational flexibility to the chatbot, without sacrificing control.

Advantageously, to increase relevance and effectiveness of the chatbot, the LLM inference service can trigger, as a function of the inference results, an optimisation task of the retrieval-augmented generation, RAG, type. RAG, which is a technique known per se, enables in the present case to combine text generation by the LLM, possible reformulation of the request (also via the LLM) and retrieval of information from a specific database, so that the LLM inference motor uses verified and controlled data rather than assumptions or incorrect or outdated information. A RAG increases the reliability of the information presented to the user and, by restricting the context passed to the LLM inference engine, reduces the risk of hallucination. It is possible to have as many RAGs as sub-modules, with RAGs that my be different from a sub-module to another one.

Finally, the LLM service can also, based on the inference result, produce an order for activating or deactivating one or several states of the state machine of the current sub-module, so as to dynamically activate or deactivate some states of a sub-module in a fully automatic manner, as a function of the real needs of the chatbot. The system can thus adapt as accurately as possible, in real time, the computing and memory resources to what is truly essential.

1. A conversational robot system, comprising:
a modular workflow segmented into a plurality of interconnected sub-modules, wherein interconnection of the sub-modules defines a progression of the workflow along a plurality of possible paths from a current sub-module to a subsequent sub-module, the plurality of sub-modules comprising:
at least one sub-module including a deterministic state machine,
at least one sub-module including a non-deterministic state machine, and
at least one sub-module including a fuzzy logic state machine;
an inference service based on Large Language Models, LLMs; and
an orchestrator module coupled, on the one hand, to the workflow and, on the other hand, to the LLM inference service, and able to issue transition orders from a current sub-module to a subsequent sub-module of the workflow in accordance with a deterministic state machine logic, wherein the LLM inference service is able to:
receive from the workflow requests emitted by at least one of the sub-modules and comprising a content of the group consisted of: requests formulated by a user of the conversational robot; conversational context data; user context data; historical data; and any combination of the above;
produce an LLM inference result from the received requests;
depending on the LLM inference result, select in real time a current sub-module, from said at least one of the sub-modules, having emitted a respective request; and
issue to the orchestrator module an order for executing transitions selected by the LLM inference result for the selected current sub-module,
and wherein the LLM inference service is also able, depending on the LLM inference result, to produce a command of the group consisted of: a “Function Calling” order for the current sub-module to call a function; an order for activating or deactivating one or several states of the state machine of the current sub-module; a triggering of an optimization task of the retrieval-augmented generation, RAG, type; and any combination of the above.

2. The conversational robot system according to claim 1, wherein each sub-module of the workflow is associated with its own repository comprising a content of the group consisted of: sub-module context data; a set of states of a state machine each defining a respective unitary action; a possible transition or plurality of transitions between states of a state machine; a set of external functions liable to be called by the sub-module; and any combination of the above.

3. The conversational robot system according to claim 1, wherein at least some sub-modules of the workflow are associated with their own repository comprising a history of the transitions between sub-modules.

4. The conversational robot system according to claim 1, wherein the function called “Function Calling” is a task capable of triggering a command of the group consisted of: transitions between states of the state machine of the current sub-module; an interaction of the current sub-module with micro-services external to the workflow, independently of an LLM inference; an interaction of the current sub-module with micro-services internal to workflow, independently of an LLM inference; and any combination of the above.

5. The conversational robot system of claim 1, wherein the RAG task is a task capable of interacting with the user of the conversational robot.
